(19) United States
(12) Patent Application Publication
(10) Pub. No.: US 2010/0238863 A1
(43) Pub. Date: Sep. 23, 2010

(54) Method and Apparatus for Power Headroom Reporting

(76) Inventors: Yu-Hsuan Guo, Taipei City (TW); Ko-Chiang Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/729,263

(22) Filed: Mar. 23, 2010

Related U.S. Application Data
(60) Provisional application No. 61/162,337, filed on Mar. 23, 2009.

(51) Int. Cl. H04W 40/00

(52) U.S. Cl. 370/328

(57) ABSTRACT

A method for performing Power Headroom Reporting (PHR) in a user equipment (UE) of a wireless communication system is disclosed. The wireless communication system supports Carrier Aggregation (CA), which enables the UE to perform transmission through multiple carriers. The method includes steps of configuring a plurality of uplink carriers, and generating at least one PHR values, each corresponding to one of the plurality of uplink carriers.

### CROSS REFERENCE TO RELATED APPLICATIONS

This application claims the benefit of U.S. Provisional Application No. 61/162,337, filed on Mar. 23, 2009 and entitled “Method and apparatus for improving PHR and carrier aggregation in a wireless communication system”, the contents of which are incorporated herein by reference.

### BACKGROUND OF THE INVENTION

1. Field of the Invention

The present invention relates to a method and apparatus for Power Headroom Reporting, and more particularly, to a method and apparatus for performing Power Headroom Reporting to support carrier aggregation in a user equipment (UE) of a wireless communication system.

2. Description of the Prior Art

Long Term Evolution wireless communication system (LTE system), an advanced high-speed wireless communication system established upon the 3G mobile telecommunication system, supports only packet-switched transmission, and tends to implement both Medium Access Control (MAC) layer and Radio Link Control (RLC) layer in one single communication site, such as in base stations (Node Bs) alone rather than in Node Bs and RNC (Radio Network Controller) respectively, so that the system structure becomes simple.

In LTE system, a MAC Protocol Data Unit (PDU) consists of a MAC header, zero or more MAC Service Data Units (SDUs), zero or more MAC control elements, and optionally padding. A MAC PDU header consists of one or more MAC PDU sub-headers, each corresponding to either a MAC SDU, a MAC control element or padding. The MAC PDU sub-headers have the same order as the corresponding MAC SDUs, MAC control elements and padding.

According to the current specifications (3GPP TS 36.321, 36.213, 36.133), MAC control elements transmitted by a UE include a buffer status report (BSR) MAC control element and a power headroom report (PHR) MAC control element. The BSR MAC control element is generated by a Buffer Status reporting procedure, and is used to provide the serving base station, or called enhanced Node B (eNB), with information about the amount of data in the uplink (UL) buffers of a UE for scheduling of uplink transmission. The PHR MAC control element is generated by a Power Headroom reporting procedure, and is used to provide the serving eNB with information about the difference between the maximum UE transmission (TX) power and an estimated TX power for Uplink Share Channel (UL-SCH). With the BSR and PHR information sent by the UE, the network can allocate radio resource to the UE and make schedule decision more efficiently.

In general, a PHR is triggered if any of the following events occurs: (1) a timer “prohibitPHR-TIMER” for prohibiting power headroom reporting expires or has expired and a path loss of the UE has changed more than a predetermined value “DL_PathlossChange” since the last power headroom report; and (2) a periodic timer “PeriodicPHR-Timer” expires, in which case the PHR is referred below to as “Periodic PHR”. After the PHR is triggered, if the UE has UL resources allocated for a new transmission for this TTI, the UE obtains the value of the power headroom from the physical layer to generate a PHR MAC control element, and restarts the timer “prohibitPHR-TIMER”. Besides, if the triggered PHR is a “Periodic PHR”, the UE restarts the periodic timer “PeriodicPHR-Timer”. Detailed operations of the PHR procedure can be referred to in related specifications (3GPP TS 36.321, 36.213, 36.133) and are not narrated herein.

On the other hand, the 3rd Generation Partnership Project (3GPP) has started to work out a next generation of the LTE system: the LTE Advanced (LTE-A) system, to meet future requirements of all kinds of communication services. Carrier Aggregation (CA) is introduced in the LTE-A system, which enables the UE to aggregate multiple carries for transmission, such that the transmission bandwidth and spectrum efficiency can be enhanced.

At present, the characteristics of carrier aggregation are quoted as below:

(1) Supporting carrier aggregation for both contiguous and non-contiguous component carriers.

(2) The aggregated number of component carriers in the uplink (UL) and the downlink (DL) can be different. For backward-compatible configuration, the aggregated numbers of component carriers in the UL and the DL should be the same.

(3) It is possible to configure a UE to aggregate a different number of component carriers in the UL and the DL to obtain different bandwidths.

(4) From a UE perspective, there is one transport block and one hybrid-ARQ (HARQ) entity per scheduled component carrier. Each transport block is mapped to a single component carrier only.

However, after the carrier aggregation is introduced, how to report the PHR value for different carriers and how to trigger the power headroom reporting are not specified. When multiple carriers are configured for transmission (due to the support of CA), if only one PHR value is reported by the UE, the eNB cannot know the power status of each uplink carrier of the UE and thus is hard to schedule radio resources to the UE efficiently. Therefore, there is a need to have the PHR procedure under carrier aggregation be specified.

### SUMMARY OF THE INVENTION

It is therefore an objective of the present invention to provide a method and apparatus for performing Power Headroom Reporting (PHR) in a user equipment (UE) of a wireless communications system.

According to the present invention, a method for performing Power Headroom Reporting (PHR) in a user equipment (UE) of a wireless communication system is disclosed. The wireless communication system supports Carrier Aggregation (CA), such that the UE is able to perform transmission through multiple carriers. The method includes steps of configuring a plurality of uplink carriers; and generating at least one PHR values, each corresponding to one of the plurality of uplink carriers.

According to the present invention, a communications device for performing Power Headroom Reporting (PHR) in a user equipment (UE) of a wireless communication system is disclosed. The wireless communication system supports Carrier Aggregation (CA), such that the UE is able to perform transmission through multiple carriers. The communications device includes a processor for executing a program code, and a memory, coupled to the processor, for storing the program code. The program code includes steps of configuring a plurality of uplink carriers; and generating at least one PHR values, each corresponding to one of the plurality of uplink carriers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a diagram of a program code of FIG. 2.

FIG. 4 is a flowchart of a process according to an embodiment of the present invention.

FIG. 5 is a flowchart of a process according to another embodiment of the present invention.

### DETAILED DESCRIPTION

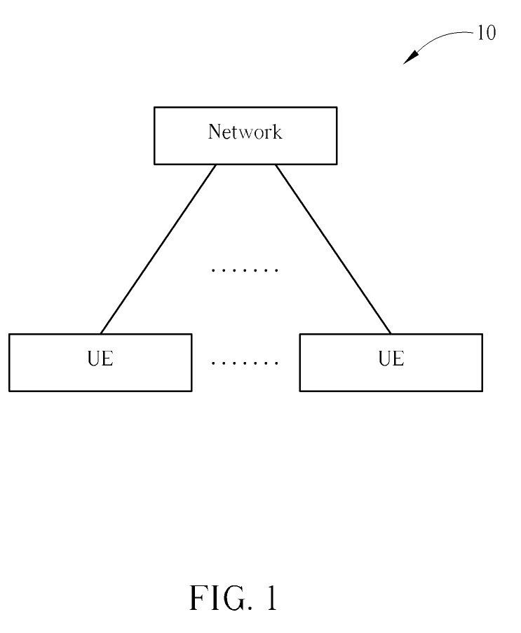

Please refer to FIG. 1, which illustrates a schematic diagram of a wireless communications system 10. The wireless communications system 10 is preferred to be an LTE advanced (LTE-A) system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

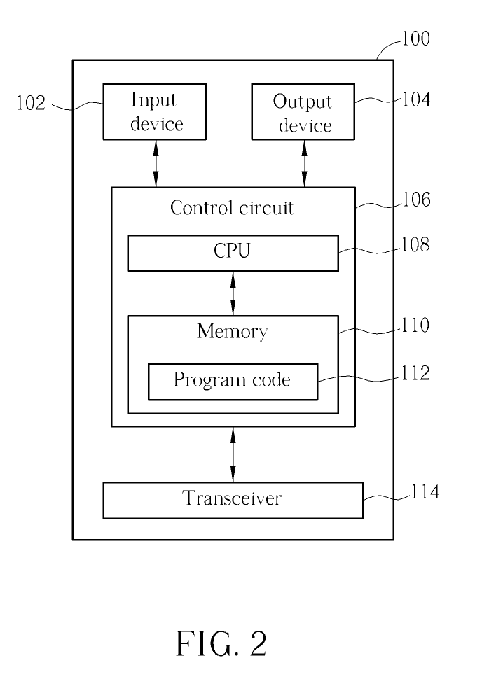

Please refer to FIG. 2, which is a functional block diagram of a communications device 100 in a wireless communications system. The communications device 100 can be utilized for realizing the UEs in FIG. 1, and the wireless communications system is preferably the LTE system. For the sake of brevity, FIG. 2 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

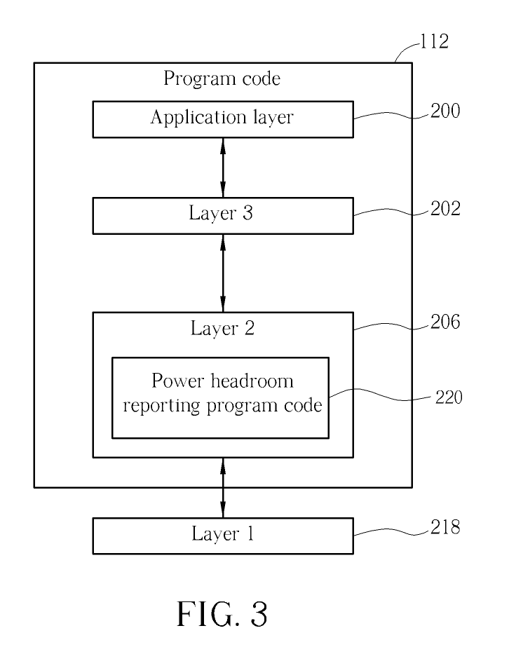

Please continue to refer to FIG. 3. FIG. 3 is a diagram of the program code 112 shown in FIG. 2. The program code 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

In LTE-A system, the program code 112 supports Carrier Aggregation (CA), such that the UE is able to perform transmission through multiple carriers. Besides, the MAC layer of the Layer 2 206 performs a Power Headroom. Reporting (PHR) procedure, to report power usage status of the UE to the serving base station, such that the network can allocate transmission resources and make scheduling decision efficiently. In such a situation, the embodiment of the present invention provides power headroom reporting program code 220 for performing power headroom reporting under the carrier aggregation, so as to enhance the performance of system resource scheduling.

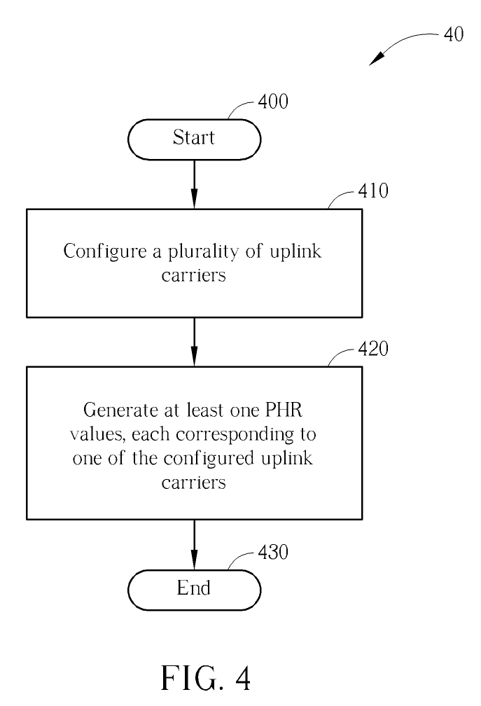

Please refer to FIG. 4, which illustrates a schematic diagram of a process 40. The process 40 is utilized for performing power headroom reporting in a UE of the wireless communications system 10, and can be compiled into the power headroom reporting program code 220. The process 40 includes the following steps:

Step 400: Start.

Step 410: Configure a plurality of uplink carriers.

Step 420: Generate at least one PHR values, each corresponding to one of the configured uplink carriers.

Step 430: End.

According to the process 40, when the carrier aggregation functionality is activated, the UE generates PHR values, each corresponding to one of the configured uplink carriers, such that the network can be aware of the power usage status of each configured uplink carrier of the UE. As a result, the network can allocate transmission resources and make scheduling decision efficiently.

As mentioned, a MAC Protocol Data Unit (PDU) consists of a MAC header, zero or more MAC Service Data Units (SDUs), zero or more MAC control elements, and optionally padding. A MAC PDU header consists of one or more MAC PDU sub-headers, each corresponding to either a MAC SDU, a MAC control element or padding. The MAC PDU sub-headers have the same order as the corresponding MAC SDUs, MAC control elements and padding.

In the embodiment of the present invention, the PHR values of the configured uplink carriers can be together transmitted in a pre-defined uplink carrier, or can be individually transmitted in its corresponding uplink carrier. For the case that the PHR values are all transmitted in the pre-defined uplink carrier, the UE may generate a plurality of PHR Control Elements carried by a same MAC PDU according to the PHR values of each configured uplink carrier. Each PHR Control Element may have an identification field, for identifying which uplink carrier the carried PHR value is corresponding to. The identification field can be included either in the PHR Control Element, or in a MAC sub-header corresponding to the PHR Control Element.

Certainly, in other embodiments, the PHR values of the configured uplink carriers can be all carried by one PHR Control Element through encoding. In this case, the PHR Control Element may need an indication field for indicating the number of carried PHR values. In addition, the PHR Control Element may have an identification field, for identifying which uplink carrier the carried PHR value is corresponding to. Similarly, the identification field can be included either in the PHR Control Element, or in a MAC sub-header corresponding to the PHR Control Element.

On the other hand, for the case that the PHR values of the configured uplink carriers are individually transmitted by its corresponding uplink carrier, the UE may generate a plurality of PHR Control Elements each carried by different MAC PDUs according to the PHR values of the configured uplink carriers. Similarly, each of the PHR Control Elements may have an identification field, for identifying which uplink carrier the carried PHR value is corresponding to.

Please note that the number of PHR values generated by the UE is generally equal to the number of configured uplink carriers. However, in some cases, such as PHR functionality of some uplink carriers is not activated, the number of PHR values would be less than the number of configured uplink carriers, but equal to the number of uplink carriers with activated PHR functionality in the configured uplink carriers

From the above, for supporting the carrier aggregation, the UE generates the PHR values, each corresponding to one of the configured uplink carriers, such that the network can be aware of the power usage status of each configured uplink carrier of the UE. As a result, the network can allocate transmission resources and make scheduling decision efficiently.

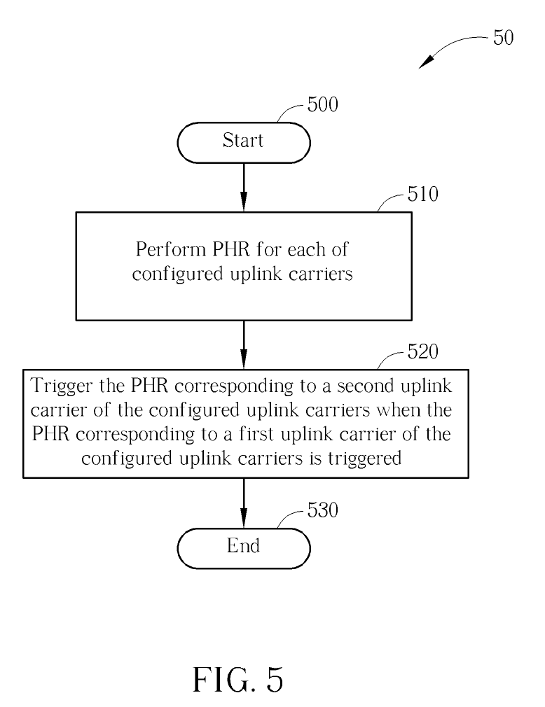

Please refer to FIG. 5, which illustrates a schematic diagram of a process 50. The process 50 is utilized for triggering power headroom reporting in a UE of the wireless communications system 10, and can be compiled into the power headroom reporting program code 220. The process 50 includes the following steps:

Step 500: Start.

Step 510: Perform PHR for each of configured uplink carriers.

Step 520: Trigger the PHR corresponding to a second uplink carrier of the configured uplink carriers when the PHR corresponding to a first uplink carrier of the configured uplink carriers is triggered.

Step 530: End.

According to the process 50, when the carrier aggregation is activated, the UE performs PHR for each of the configured uplink carriers, respectively. In such a situation, when the PHR corresponding to a first uplink carrier of the configured uplink carriers is triggered, the UE triggers the PHR corresponding to a second uplink carrier of the configured uplink carriers. That is to say, in the embodiment of the present invention, the PHR triggering of each uplink carrier is linked to each other.

For example, if the PHR corresponding to the first uplink carrier is triggered due to a path loss change of the first uplink carrier, since the path loss of the second carrier may also change, the UE shall trigger the PHR of the second uplink carrier or other configured uplink carriers, for enabling the network to be aware of the power usage status of each uplink carrier of the UE, such that the network is able to allocate radio resources to the UE.

Certainly, the PHR corresponding to the first uplink carrier can also be triggered due to a periodic timer, which also belongs to the scope of the present invention, as long as the PHR triggering of each uplink carrier is linked to each other.

As mentioned in the prior art section, the UE of the LTE system utilizes a periodic timer “periodicPHR-Timer” and a timer “prohibitPHR-TIMER” for prohibiting power headroom reporting to control the PHR triggering. However, for the LTE-A system that supports the carrier aggregation, since the PHR shall be performed for each configured uplink carrier, if only one set of the above timers is configured in the UE, it is not sufficient to control the PHR triggering for all of the configured uplink carriers.

Therefore, in the embodiment of the present invention, the UE may have multiple sets of timers, each corresponding to one of the configured uplink carriers, for controlling the PHR triggering of the configured uplink carriers. The said timers may include a periodic timer “periodicPHR-Timer” and a timer “prohibitPHR-TIMER” for prohibiting power headroom reporting, but are not restricted herein. In addition, the number of each kind of timer is preferably equal to the number of configured uplink timers.

On the other hand, when the PHR of some configured uplink carrier is transmitted, the embodiment of the present invention keeps all other triggered PHR pending to allow the trigger PHR able to be sent to the network continuously. Such variation also belongs to the scope of the present invention.

From the above, for supporting the carrier aggregation, the UE shall perform the PHR for each of the configured uplink carriers. Thus, the process 50 provides the PHR triggering method, for allowing the PHR triggering of each configured uplink carrier being linked to each other. As a result, the network is able to obtain power usage status of each configured uplink carrier, and performs resource allocation and scheduling decision more efficiently.

Please note that, in order to have the description clearly, Applicant illustrates the invention by the process 40 and the process 50, separately. However, those skilled in the art can certainly combine the process 40 with the process 50 to meet practical requirements, which also belongs to the scope of the present invention.

In summary, the present invention provides a method and apparatus for performing Power Headroom Reporting to support carrier aggregation in a user equipment (UE) of a wireless communication system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing Power Headroom Reporting (PHR) in a user equipment (UE) of a wireless communication system, the wireless communication system supporting Carrier Aggregation (CA) such that the UE is able to perform transmission through multiple carriers, the method comprising:
configuring a plurality of uplink carriers; and
generating at least one PHR values, each corresponding to one of the plurality of uplink carriers.

2. The method of claim 1, wherein the at least one PHR values are carried by PHR Control Elements.

3. The method of claim 2, wherein the at least one PHR values are each carried by one PHR Control Element.

4. The method of claim 2, wherein the PHR Control Elements each have an identification field, for identifying which uplink carrier the carried PHR value is corresponding to.

5. The method of claim 4, wherein the identification field is in a Medium Access Control (MAC) sub-header corresponding to the PHR Control Element.

6. The method of claim 4, wherein the identification field is in the PHR Control Element.

7. The method of claim 2, wherein the at least one PHR values are all carried by a single PHR Control Element.

8. The method of claim 2, wherein the PHR Control Elements each have an indication field, for indicating the number of the at least one PHR values.

9. The method of claim 1, wherein the number of the at least one PHR values is equal to the number of the plurality of uplink carriers.

10. The method of claim 1, wherein the number of the at least one PHR values is equal to the number of uplink carriers with activated PHR functionality in the plurality of uplink carriers.

11. The method of claim 1, wherein the at least one PHR values are each transmitted by a corresponding uplink carrier of the plurality of uplink carriers.

12. The method of claim 1, wherein the at least one PHR values are all transmitted by a pre-defined uplink carrier of the plurality of uplink carriers.

13. The method of claim 1 further comprising:
performing PHR for each of the plurality of uplink carriers; and
triggering the PHR corresponding to a second uplink carrier of the plurality of uplink carriers when the PHR corresponding to a first uplink carrier of the plurality of uplink carriers is triggered.

14. The method of claim 13, wherein the PHR corresponding to the first uplink carrier is triggered due to a path loss change of the first uplink carrier.

15. The method of claim 13, wherein the PHR corresponding to the first uplink carrier is triggered due to a periodic timer.

16. The method of claim 13, wherein a timer prohibitPHR-Timer of the second uplink carrier is not running.

17. The method of claim 1, wherein the UE has a plurality of timers, each corresponding to the plurality of uplink carriers, for controlling PHR triggering in the plurality of uplink carriers.

18. The method of claim 17, wherein the plurality of timers are each a periodic timer periodicPHR-Timer, for periodically performing the PHR triggering in the plurality of uplink carriers.

19. The method of claim 17, wherein the plurality of timers are each a timer prohibitPHR-Timer, for prohibiting the PHR triggering in the plurality of uplink carriers during operation.

20. The method of claim 17, wherein the number of the plurality of timers is equal to the number of the plurality of uplink carriers.

21. The method of claim 17 further comprising:
keeping all other triggered PHR pending when the PHR corresponding to a third uplink carrier of the plurality of uplink carriers is sent.

22. A communication device for performing Power Headroom Reporting (PHR) in a user equipment (UE) of a wireless communication system, the wireless communication system supporting Carrier Aggregation (CA) such that the UE is able to perform transmission through multiple carriers, the communication device comprising:
a processor for executing a program code; and
a memory coupled to the processor for storing the program code;
wherein the program code comprises:
configuring a plurality of uplink carriers; and
generating at least one PHR values, each corresponding to one of the plurality of uplink carriers.

23. The communication device of claim 22, wherein the at least one PHR values are carried by PHR Control Elements.

24. The communication device of claim 23, wherein the at least one PHR values are each carried by one PHR Control Element.

25. The communication device of claim 23, wherein the PHR Control Elements each have an identification field, for identifying which uplink carrier the carried PHR value is corresponding to.

26. The communication device of claim 25, wherein the identification field is in a Medium Access Control (MAC) sub-header corresponding to the PHR Control Element.

27. The communication device of claim 25, wherein the identification field is in the PHR Control Element.

28. The communication device of claim 23, wherein the at least one PHR values are all carried by a single PHR Control Element.

29. The communication device of claim 23, wherein the PHR Control Elements each have an indication field, for indicating the number of the at least one PHR values.

30. The communication device of claim 22, wherein the number of the at least one PHR values is equal to the number of the plurality of uplink carriers.

31. The communication device of claim 22, wherein the number of the at least one PHR values is equal to the number of uplink carriers with activated PHR functionality in the plurality of uplink carriers.

32. The communication device of claim 22, wherein the at least one PHR values are each transmitted by a corresponding uplink carrier of the plurality of uplink carriers.

33. The communication device of claim 22, wherein the at least one PHR values are all transmitted by a pre-defined uplink carrier of the plurality of uplink carriers.

34. The communication device of claim 22, wherein the program code further comprises:
performing PHR for each of the plurality of uplink carriers; and
triggering the PHR corresponding to a second uplink carrier of the plurality of uplink carriers when the PHR corresponding to a first uplink carrier of the plurality of uplink carriers is triggered.

35. The communication device of claim 34, wherein the PHR corresponding to the first uplink carrier is triggered due to a path loss change of the first uplink carrier.

36. The communication device of claim 34, wherein the PHR corresponding to the first uplink carrier is triggered due to a periodic timer.

37. The communication device of claim 34, wherein a timer prohibitPHR-Timer of the second uplink carrier is not running.

38. The communication device of claim 22, wherein the UE has a plurality of timers, each corresponding to the plurality of uplink carriers, for controlling PHR triggering in the plurality of uplink carriers.

39. The communication device of claim 38, wherein the plurality of timers are each a periodic timer periodicPHR-Timer, for periodically performing the PHR triggering in the plurality of uplink carriers.

40. The communication device of claim 38, wherein the plurality of timers are each a timer prohibitPHR-Timer, for prohibiting the PHR triggering in the plurality of uplink carriers during operation.

41. The communication device of claim 38, wherein the number of the plurality of timers is equal to the number of the plurality of uplink carriers.

42. The communication device of claim 22, wherein the program code further comprises:
keeping all other triggered PHR pending when the PHR corresponding to a third uplink carrier of the plurality of uplink carriers is sent.
